(19) United States
(12) Patent Application Publication
(10) Pub. No.: US 2012/0276801 A1
(43) Pub. Date: Nov. 1, 2012

(54) TRANSPORTING DEVICE AND DISPLAY PANEL ASSEMBLY APPARATUS AND METHOD USING THE SAME

(75) Inventors: Chengming He, Shenzhen (CN); Chien-pang Lee, Shenzhen (CN)

(73) Assignee: SHENZHEN CHINA STAR OPTOELECTRONICS TECHNOLOGY CO., LTD., Shenzhen (CN)

(21) Appl. No.: 12/997,906

(22) PCT Filed: Nov. 23, 2010
(86) PCT No.: PCT/CN10/78991

§ 371 Date: Dec. 14, 2010

(30) Foreign Application Priority Data
Oct. 26, 2010 (CN) 201010523915.2

(51) Int. Cl. H01J 9/46; H01J 9/26

(52) U.S. Cl. 445/25; 445/66

(57) ABSTRACT

The present invention provides a transporting device, a display panel assembly apparatus and a method using the same. The display panel assembly apparatus comprises a liquid crystal filling device, an alignment assembly device, a transporting device and a curing device. The transporting device comprises at least one transporting unit and at least one auxiliary curing unit. The display panel assembly method comprises the following steps: forming a liquid crystal on a first substrate; aligning and assembling a second substrate on the first substrate; pre-curing a sealant of a display panel when transporting the display panel; and curing the sealant of the display panel completely. The present invention can improve the problem that the sealant is damaged by the spreading of the liquid crystal due to the long transport time.

### FIELD OF THE INVENTION

The present invention relates to a field of a liquid crystal display technology, and more particularly to a transporting device, a display panel assembly apparatus and a method using the same.

### BACKGROUND OF THE INVENTION

Liquid crystal displays (LCDs) have been widely applied in electrical products. Currently, most of LCDs are backlight type LCDs which comprise a liquid crystal panel and a backlight module.

The liquid crystal panel is composed of two transparent substrates and a liquid crystal sealed there-between. In an assembly process of the liquid crystal panel, the liquid crystal is filled and sealed between the transparent substrates. Currently, the methods for filling the crystal panel between the transparent substrates may be a vacuum siphon method and a one-drop filling (ODF) method. The filling time of the conventional vacuum siphon method is too long, and thus the ODF method is more suitable to a large-scale panel.

In the ODF process, the liquid crystal is first dispensed on a glass substrate, and then another glass substrate can be aligned and assembled with the glass substrate with the dispensed liquid crystal, thereby forming a liquid crystal cell between the two glass substrates. Subsequently, a sealant between the two glass substrates is cured, thereby forming the liquid crystal panel.

However, before curing the sealant, it takes a specific time to transport the liquid crystal panel to an ultraviolet (UV) lighting machine for curing the sealant. When the specific time exceeds a limit time (about 240 seconds), i.e. when the transport time is too long, the uncured sealant is susceptible to be damaged by the spreading of the liquid crystal, resulting in the damage of the liquid crystal cell.

As a result, it is necessary to provide a transporting device, a display panel assembly apparatus and a method using the same to solve the problems existing in the conventional technologies, as described above.

### SUMMARY OF THE INVENTION

A primary object of the present invention is to provide a transporting device configured to transport a display panel from an alignment assembly device to a curing device, wherein the transporting device comprises: at least one transporting unit configured to move the display panel; and at least one auxiliary curing unit disposed at one or more sides of the transporting unit configured to pre-cure a sealant of the display panel.

Another object of the present invention is to provide a display panel assembly apparatus, wherein the display panel assembly apparatus comprises: a liquid crystal filling device configured to form a liquid crystal on a first substrate, wherein a sealant needed to be cured is formed on the first substrate; an alignment assembly device configured to align and assemble a second substrate on the first substrate for forming a display panel; a transporting device configured to transport the display panel from the alignment assembly device, wherein the transporting device comprises: at least one transporting unit configured to move the display panel; and at least one auxiliary curing unit disposed at one or more sides of the transporting unit configured to pre-cure the sealant of the display panel; and a curing device configured to completely cure the sealant of the display panel transported by the transporting device.

A further object of the present invention is to provide a display panel assembly method, characterized in that: the method comprises the following steps: forming a liquid crystal on a first substrate; aligning and assembling a second substrate on the first substrate for forming a display panel by using a alignment assembly device; transporting the display panel from the alignment assembly device to a curing device; pre-curing a sealant of the display panel when transporting the display panel; and curing the sealant of the display panel completely by using the curing device.

In one embodiment of the present invention, the at least one transporting unit comprises a vacuum box robot arm, an inverting transporting device and/or a curing robot arm.

In one embodiment of the present invention, the at least one auxiliary curing unit comprises a plurality of light sources.

In one embodiment of the present invention, the wavelength of the light emitted from the auxiliary curing unit is between 330 nm and 440 nm.

In one embodiment of the present invention, the wavelength of the light emitted from the auxiliary curing unit is between 380 nm and 440 nm.

In one embodiment of the present invention, a lighting time of the auxiliary curing unit is longer than 60 seconds.

In one embodiment of the present invention, the auxiliary curing unit is disposed above the transporting unit.

In one embodiment of the present invention, the auxiliary curing unit is disposed at two opposite sides of the transporting unit.

In one embodiment of the present invention, the auxiliary curing unit is at least one heater.

In one embodiment of the present invention, a heating temperature of the auxiliary curing unit is adjusted according to the extent to which the sealant is cured.

In one embodiment of the present invention, the transporting unit is at least one roller device.

In one embodiment of the present invention, the alignment assembly device assembles a first substrate and a second substrate in a vacuum environment.

In one embodiment of the present invention, the surface of the sealant is at least cured by the auxiliary curing unit.

In one embodiment of the present invention, the sealant of the display panel is pre-cured by using a light curing method.

In one embodiment of the present invention, the wavelength of the light of the light curing method is between 330 nm and 440 nm.

In one embodiment of the present invention, a lighting time of the light curing method is longer than 60 seconds.

In one embodiment of the present invention, the sealant of the display panel is pre-cured by using a heat curing method.

In one embodiment of the present invention, a heating temperature of the heat curing method is adjusted according to the extent to which the sealant is cured.

In one embodiment of the present invention, the circuit board comprises an electrically conductive layer and a dielectric layer, and the electrically conductive layer is formed on the dielectric layer, and the supporting unit is disposed on the electrically conductive layer of the circuit board.

In one embodiment of the present invention, the height difference between the reflective layer and the lighting surfaces of the light sources is less than 1 mm.

In one embodiment of the present invention, the height difference between the reflective layer and the lighting surfaces of the light sources is less than 100 μm.

In one embodiment of the present invention, the backlight module further comprises a light guide plate, and the light sources and the circuit board are disposed at one side of the light guide plate.

In comparison with the conventional panel has the problem that the sealant is susceptible to be damaged by the spreading of the liquid crystal due to the long transport time, the transporting device, the display panel assembly apparatus and the assembly method using the same can pre-cure the sealant of the display panel for strengthening the sealant, thereby improving the problem that the sealant is damaged by the spreading of the liquid crystal due to the long transport time. Therefore, the transporting device and the display panel assembly apparatus using the same of the present invention can enhance the assembly yield of the display panel.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a schematic diagram showing a display panel assembly apparatus according to an embodiment of the present invention;

FIG. 2 is a cross-sectional view showing a display panel according to an embodiment of the present invention;

FIG. 3 is a schematic diagram showing an alignment assembly device according to the embodiment of FIG. 1;

FIG. 4 is a schematic diagram showing a transporting device according to an embodiment of the present invention;

FIG. 5 is a flow diagram showing a method for assembling the display panel of the present invention; and

FIG. 6 is a schematic diagram showing a transporting device according to another embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

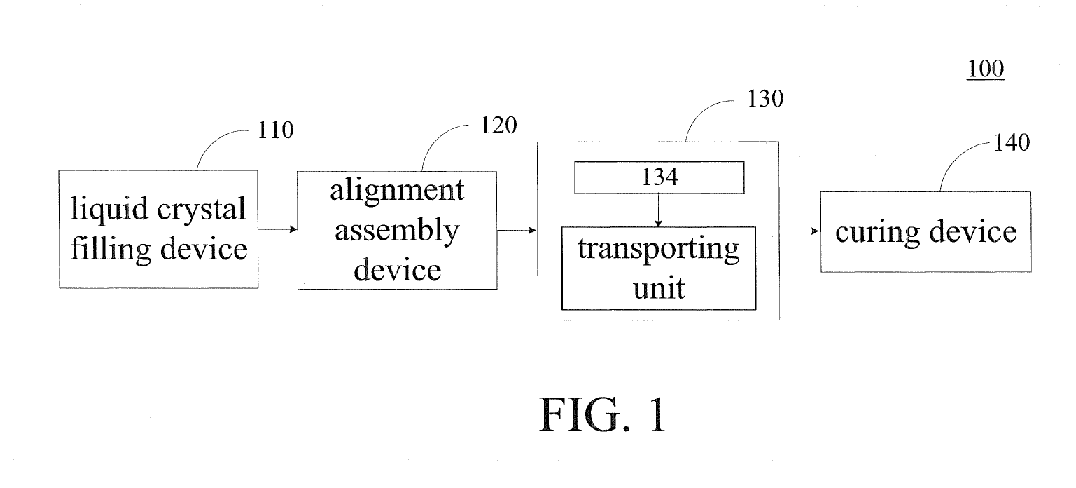

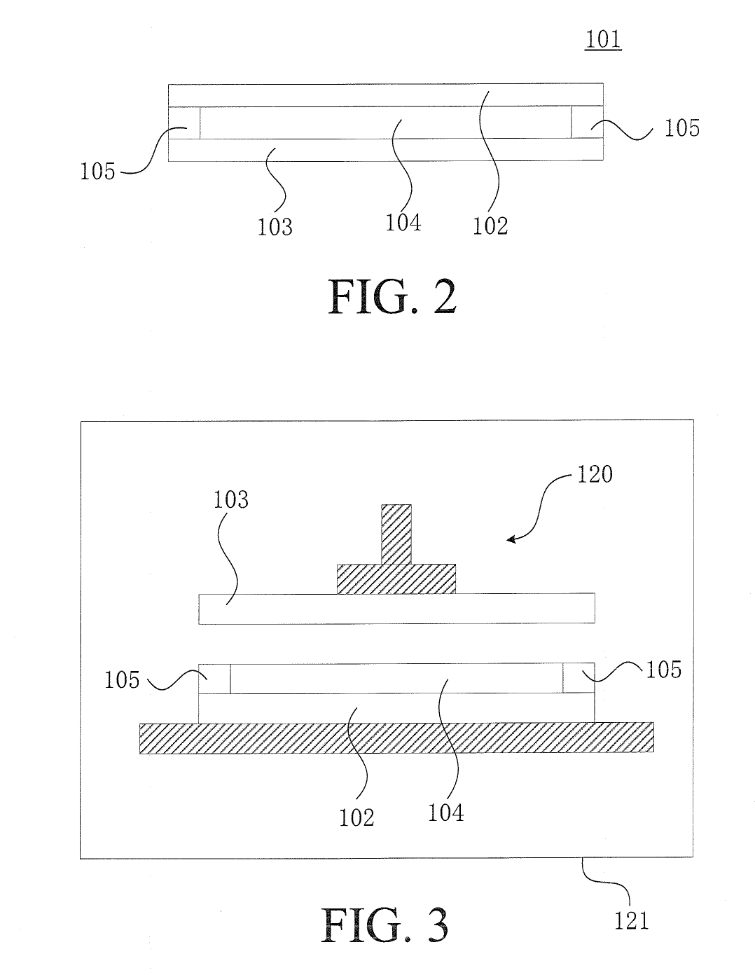

Referring to FIG. 1 and FIG. 2, FIG. 1 is a schematic diagram showing a display panel assembly apparatus according to an embodiment of the present invention, and FIG. 2 is a cross-sectional view showing a display panel according to an embodiment of the present invention. The display panel assembly apparatus 100 of the present embodiment may be configured to manufacture a liquid crystal display panel 101. The liquid crystal display panel 101 comprises a first substrate 102, a second substrate 103, a liquid crystal layer 104 and a sealant 105. The liquid crystal layer 104 and a sealant 105 are formed between the first substrate 102 and the second substrate 103. The sealant 105 can enclose and seal the liquid crystal layer 104 to form a liquid crystal cell. In this embodiment, only one sealant 105 between the first substrate 102 and the second substrate 103 is illustrated in the diagram. However, two or more sealants 105 may also be disposed there-between. At this time, the liquid crystal display panel 101 is cut to an appropriate size after the following curing step.

Referring to FIG. 2 again, the first substrate 102 and the second substrate 103 may be glass substrates or flexible plastic substrates. In this embodiment, the first substrate 102 may be a glass substrate or other material substrate with color filters (CF), and the second substrate 103 may be a glass substrate or other material substrate with a thin film transistor (TFT) array. The sealant 105 is formed as a frame-shaped structure to enclose the liquid crystal layer 104. The sealant 105 may be a light-curing sealant or a heat-curing sealant. The light-curing sealant may be, for example, a UV Curable adhesive or a visible light curing glue.

Referring to FIG. 1 and FIG. 3, FIG. 3 is a schematic diagram showing an alignment assembly device according to an embodiment of the present invention. The display panel assembly apparatus 100 of the present embodiment may comprise a liquid crystal filling device 110, an alignment assembly device 120, a transporting device 130 and a curing device 140. The liquid crystal filling device 110 is configured to form a liquid crystal on the first substrate 102, wherein the sealant 105 needed to be cured is formed on the first substrate 102. The liquid crystal filling device 110 can dispense the liquid crystal within the sealant 105 on the first substrate 102 by using, for example, an ODF method. When the liquid crystal is dispensed on the first substrate 102 by the liquid crystal filling device 110, the coated sealant 105 on the first substrate 102 is uncured. The alignment assembly device 120 is disposed downstream of the liquid crystal filling device 110 for aligning and assembling the second substrate 103 on the first substrate 102 to form the display pane 101. Referring to FIG. 3 again, the alignment assembly device 120 preferably aligns and assembles the first substrate 102 and the second substrate 103 in a vacuum environment to reduce defects, such as bubbles. For example, in this embodiment, the alignment assembly device 120 is positioned in a vacuum box to align and assemble the first substrate 102 and second substrate 103. The curing device 140 is disposed downstream of the alignment assembly device 120 configured to completely cure the sealant 105. In this embodiment, the curing device 140 can cure the sealant 105 between the first substrate 102 and second substrate 103 by a light curing method or a heat curing method. In the light curing method, a visible light (wavelength about 380 nm-780 nm) or an invisible light (such as UV light or infrared light) is used to cure the sealant 105. At this time, the curing device 140 may be a UV lighting machine which emits light to the sealant 105 for light curing. Furthermore, the heat curing method of the curing device 140 may be a hot pressure method for curing the sealant 105.

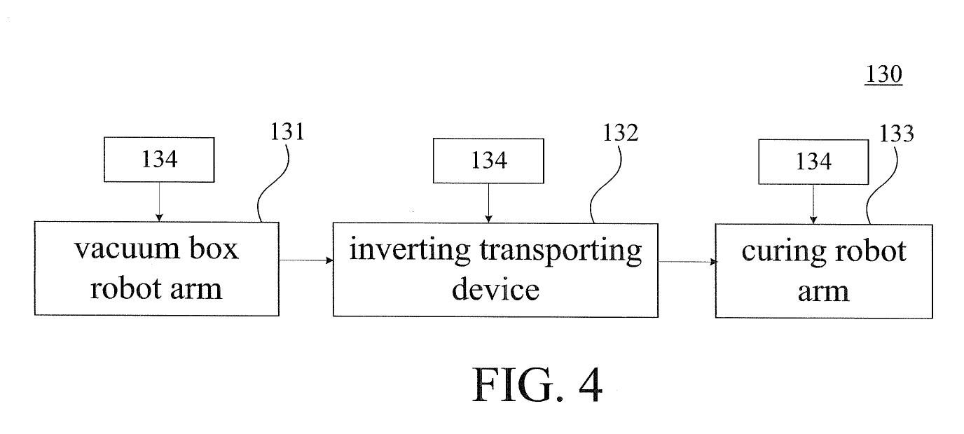

Referring to FIG. 1 and FIG. 4, FIG. 4 is a schematic diagram showing a transporting device according to an embodiment of the present invention. The transporting device 130 of the display panel assembly apparatus 100 of the present embodiment may be disposed between the alignment assembly device 120 and the curing device 140. The transporting device 130 is configured to transport the display panel 101 from the alignment assembly device 120 to the curing device 140, and to pre-cure the sealant 105. In this embodiment, the transporting device 130 may comprise a plurality of transporting units 131, 132 and 133 and at least one auxiliary curing unit 134. The transporting units 131, 132 and 133 are configured to move the display panel 101. The transporting device 130 can transport the display panel 101 from the alignment assembly device 120 to the curing device 140 by using the transporting units 131, 132 and 133. The transporting units of the transporting device 130 may be a vacuum box robot arm 131, an inverting transporting device 132 and a curing robot arm 133. The vacuum box robot arm 131 can be disposed downstream of the alignment assembly device 120. For example, the vacuum box robot arm 131 is disposed at the exit of the vacuum box for transporting the display panel 101 to the inverting transporting device 132. The inverting transporting device 132 may be disposed between the vacuum box robot arm 131 and the curing robot arm 133 for inverting the display panel 101. The display panel 101 may be transported to the curing device 140 by the curing robot arm 133 for completely curing the sealant 105 between the first substrate 102 and second substrate 103.

In one embodiment, the transporting units of the transporting device 130 can also move the display panel 101 in other manners, such as roller devices.

Referring to FIG. 4 again, the at least one auxiliary curing unit 134 is disposed at one or more sides of the transporting units 131, 132 and 133 for initially pre-cure the sealant 105 of the display panel 101, thereby significantly improving the problem that the uncured sealant 105 is susceptible to be damaged by the spreading of the liquid crystal due to the long transport time (such as longer than 240 seconds). Preferably, the surface of the sealant 105 is at least cured by the auxiliary curing unit 134 for raise the strength of the sealant 105, and the sealant 105 can be completely cured by the curing device 140. In this embodiment, the at least one auxiliary curing unit 134 may be a plurality of light sources which emit light reacting with the material of the sealant 105 for light curing. The wavelength of the light of the auxiliary curing unit 134 is, for example, between 330 nm and 440 nm, and preferably between 380 nm and 440 nm (visible light wavelength) for reducing the damage to human. At this time, the lighting time of the auxiliary curing unit 134 may be longer than 60 seconds for curing. The auxiliary curing unit 134 of the present embodiment may be, for example, disposed above or at two opposite sides of the transporting units 131, 132 and/or 133 for initially lighting the sealant 105 in the process of transporting the display panel 101, thereby raising the strength of the sealant 105 and improving the problem that the sealant 105 is damaged by the spreading of the liquid crystal.

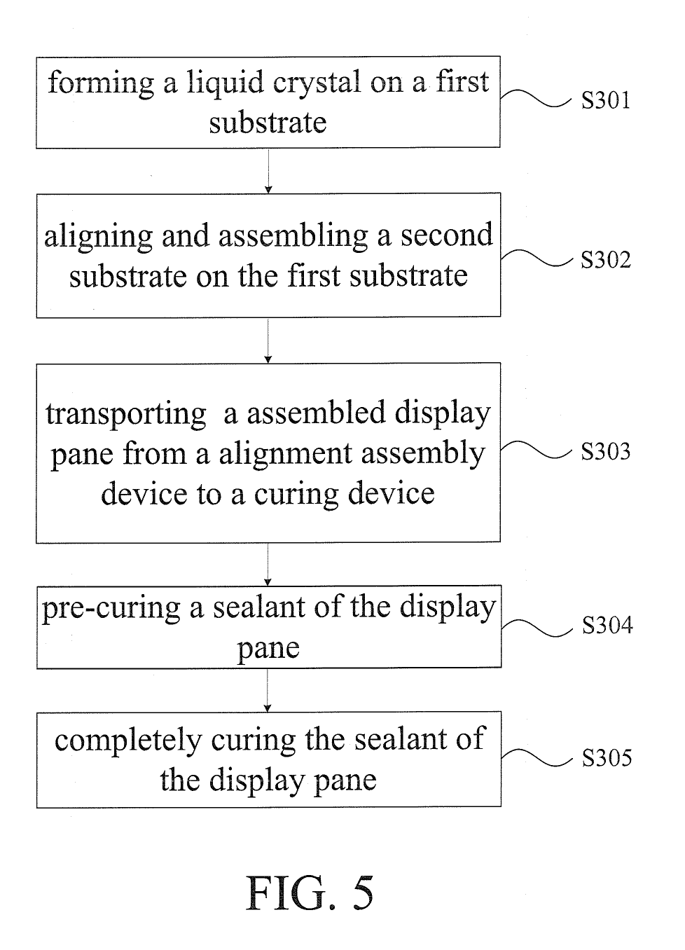

Referring to FIG. 5, a flow diagram showing a method for assembling the display panel according to an embodiment of the present invention is illustrated. When using the display panel assembly apparatus 100 of the present embodiment to assemble the display panel 101, the liquid crystal is formed on the first substrate 102 by using the liquid crystal filling device 110 (step 301). Subsequently, the second substrate 103 can be aligned and assembled on the first substrate 102 by using the alignment assembly device 120 (step 302), thereby forming the display pane 101. Subsequently, the transporting device 130 can use the transporting units 131, 132 and/or 133 to move the display pane 101, and thus the assembled display pane 101 can be transported from the alignment assembly device 120 to the curing device 140 (step 303). At this time, the display pane 101 can be transported to the inverting transporting device 132 by the vacuum box robot arm 131 of the transporting device 130, and then the display pane 101 can be inverted by the inverting transporting device 132 and transported to the curing device 140 by the curing robot arm 133. When the display pane 101 is moved by the transporting units 131, 132 and/or 133 of the transporting device 130, the sealant 105 of the display pane 101 can be pre-cured by the auxiliary curing unit 134 at one or more sides of the transporting units 131, 132 and/or 133 (step 304) for strengthening the sealant 105 and improving the problem that the sealant 105 is damaged by the spreading of the liquid crystal due to the long transport time, wherein the pre-curing method of the auxiliary curing unit 134 can be a light curing method or a heat curing method. Therefore, the transporting device 130 and the display panel assembly apparatus 100 using the same can enhance the assembly yield of the display pane 101. Thereafter, the sealant 105 of the display pane 101 can be completely cured by the curing device 140 (step 305), thereby achieving the assembly of the display pane 101.

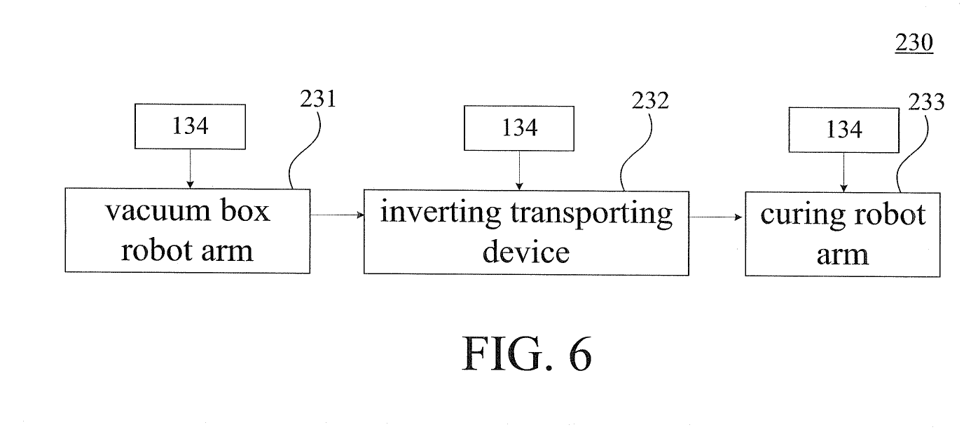

Referring to FIG. 6, a schematic diagram showing a transporting device according to another embodiment of the present invention is illustrated. The at least one auxiliary curing unit 234 of the transporting device 230 can pre-cure the sealant 105 of the display pane 101 by using the heat curing method. At this time, the auxiliary curing unit 234 may be at least one heater disposed at one or more sides of the transporting units 231, 232 and/or 233 for initially pre-curing the sealant 105 of the display pane 101 in the heat curing manner. Moreover, the heating temperature of the auxiliary curing unit 234 can be adjusted according to the extent to which the sealant 105 is cured, and the surface of the sealant 105 is at least cured for raising the strength thereof.

As described above, during the process of transporting the display panel from the alignment assembly device to the curing device, the transporting device, the display panel assembly apparatus and the assembly method using the same of the present invention can perform an auxiliary pre-curing continuously or intermittently for strengthening the sealant and improving the problem that the sealant is damaged by the spreading of the liquid crystal due to the long transport time. Therefore, the transporting device and the display panel assembly apparatus using the same of the present invention can reduce the possibility of scrapping the display panel and enhance the assembly yield thereof.

The present invention has been described with a preferred embodiment thereof and it is understood that many changes and modifications to the described embodiment can be carried out without departing from the scope and the spirit of the invention that is intended to be limited only by the appended claims.

1. A display panel assembly apparatus, characterized in that: the display panel assembly apparatus comprises:
a liquid crystal filling device configured to form a liquid crystal on a first substrate, wherein a sealant needed to be cured is formed on the first substrate;
an alignment assembly device configured to align and assemble a second substrate on the first substrate for forming a display panel;
a transporting device configured to transport the display panel from the alignment assembly device, wherein the transporting device comprises:
at least one transporting unit configured to move the display panel; and
at least one auxiliary curing unit disposed at one or more sides of the transporting unit configured to pre-cure the sealant of the display panel; and
a curing device configured to completely cure the sealant of the display panel transported by the transporting device.

2. A transporting device configured to transport a display panel from an alignment assembly device to a curing device, characterized in that: the transporting device comprises:
at least one transporting unit configured to move the display panel; and
at least one auxiliary curing unit disposed at one or more sides of the transporting unit configured to pre-cure a sealant of the display panel.

3. The transporting device according to claim 2, characterized in that: the at least one transporting unit comprises a vacuum box robot arm, an inverting transporting device and/or a curing robot arm.

4. The transporting device according to claim 2, characterized in that: the at least one auxiliary curing unit comprises a plurality of light sources.

5. The transporting device according to claim 4, characterized in that: the wavelength of the light emitted from the auxiliary curing unit is between 330 nm and 440 nm.

6. The transporting device according to claim 5, characterized in that: the wavelength of the light emitted from the auxiliary curing unit is between 380 nm and 440 nm.

7. The transporting device according to claim 4, characterized in that: a lighting time of the auxiliary curing unit is longer than 60 seconds.

8. The transporting device according to claim 2, characterized in that: the auxiliary curing unit is disposed above the transporting unit.

9. The transporting device according to claim 2, characterized in that: the auxiliary curing unit is disposed at two opposite sides of the transporting unit.

10. The transporting device according to claim 2, characterized in that: the auxiliary curing unit is at least one heater.

11. The transporting device according to claim 10, characterized in that: a heating temperature of the auxiliary curing unit is adjusted according to the extent to which the sealant is cured.

12. The transporting device according to claim 2, characterized in that: the transporting unit is at least one roller device.

13. The transporting device according to claim 2, characterized in that: the alignment assembly device assembles a first substrate and a second substrate in a vacuum environment.

14. The transporting device according to claim 2, characterized in that: the surface of the sealant is at least cured by the auxiliary curing unit.

15. A display panel assembly method, characterized in that: the method comprises the following steps:
forming a liquid crystal on a first substrate;
aligning and assembling a second substrate on the first substrate for forming a display panel by using a alignment assembly device;
transporting the display panel from the alignment assembly device to a curing device;
pre-curing a sealant of the display panel when transporting the display panel; and
curing the sealant of the display panel completely by using the curing device.

16. The method according to claim 15, characterized in that: the sealant of the display panel is pre-cured by using a light curing method.

17. The method according to claim 16, characterized in that: the wavelength of the light of the light curing method is between 330 nm and 440 nm.

18. The method according to claim 16, characterized in that: a lighting time of the light curing method is longer than 60 seconds.

19. The method according to claim 15, characterized in that: the sealant of the display panel is pre-cured by using a heat curing method.

20. The transporting device according to claim 19, characterized in that: a heating temperature of the heat curing method is adjusted according to the extent to which the sealant is cured.
